(19) United States
(12) Patent Application Publication
(10) Pub. No.: US 2015/0371232 A1
(43) Pub. Date: Dec. 24, 2015

(54) PREEMPTIVE CREDIT AND DEBIT CARD FRAUD PROTECTION SYSTEM

(71) Applicant: Safanad Inc., New York, NY (US)

(72) Inventors: Jerry Wells, Sarasota, FL (US); Vincent Pica, II, New York, NY (US); Adam Hyer, Tannersville, NY (US)

(21) Appl. No.: 14/678,195

(22) Filed: Apr. 3, 2015

Related U.S. Application Data
(60) Provisional application No. 61/974,556, filed on Apr. 3, 2014.

(51) Int. Cl. G06Q 20/40; G06Q 20/32

(52) U.S. Cl. CPC G06Q 20/409; G06Q 20/32

(57) ABSTRACT

A system for preventing credit or debit card fraud can include at least one receiver configured to receive a location of usage of a card at a time of usage of the card and the location of an authentication device, a comparison module configured to compare the location of usage of the card to the location of the authentication device and determine if the location of usage of the card is within a threshold range of the location of the authentication device, and an activation module configured to allow the card to function at the location of usage if the location of usage is within the threshold range of the location of the authentication device.

### CROSS-REFERENCE TO RELATED APPLICATION

This application claims the benefit of priority from U.S. Provisional Patent Application No. 61/974,556 filed Apr. 3, 2014, which is incorporated herein by reference in its entirety.

### FIELD OF THE DISCLOSURE

The disclosed embodiments generally relate to a method and computerized system for preemptive credit and debit card fraud protection.

### BACKGROUND OF THE DISCLOSURE

Credit and debit card fraud is a common way for thieves to access funds from a credit line or cash account that the thieves should have no access to. Thieves can steal cards from unsuspecting people and use them before the card holder can notify the issuer that the card is stolen. More recently, fraud protection has become critical as a result of wily thieves who can steal information and create fake cards that look and function as the actual card would.

Present fraud detection systems use a wide swath of algorithms to determine after the fact if a fraud has occurred and cannot accurately predict actual fraud to determine when to prevent a sale. As a result, a cunning thief can perpetuate a fraud undetected for quite some time (e.g., until a user notices a discrepancy in their account), and can only be reacted to after the fact.

Accordingly, previous systems lack the ability to prevent fraud from occurring and only act to identify a fraud after the fact which exposes the card holder and/or the card issuer potentially substantial liability.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer implemented method for determining a credit or debit card fraud is described and can include receiving or determining a location of usage of a card, receiving or determining a location of an authentication device, comparing the location of usage of the card to the location of the mobile computing device, and determining if the mobile computing device and the card are in sufficient proximity to allow the card to be used.

In at least one aspect of this disclosure, a system for preventing credit or debit card fraud can include at least one receiver configured to receive a location of usage of a card at a time of usage of the card and the location of an authentication device, a comparison module configured to compare the location of usage of the card to the location of the authentication device and determine if the location of usage of the card is within a threshold range of the location of the authentication device, and an activation module configured to allow the card to function at the location of usage if the location of usage is within the threshold range of the location of the authentication device.

In at least one aspect of this disclosure, a mobile device can include a location determination unit and a reporting module configured to selectively report a location from the location determination unit of the mobile device to a system for preventing credit or debit card fraud.

This summary section is provided to introduce a selection of concepts in a simplified form that are further described subsequently in the detailed description section. This summary section is not intended to identify key features or essential features of the claimed subject matter, nor is it intended to be used to limit the scope of the claimed subject matter.

### BRIEF DESCRIPTION OF THE DRAWINGS

The accompanying appendices and/or drawings illustrate various non-limiting, examples, inventive aspects in accordance with the present disclosure:

FIG. 1 illustrates an example communication network in accordance with an illustrated embodiment;

FIG. 2 illustrates a network computer device/node in accordance with an illustrated embodiment; and

FIG. 3 is systematic diagram of a system in accordance with an illustrated embodiment.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

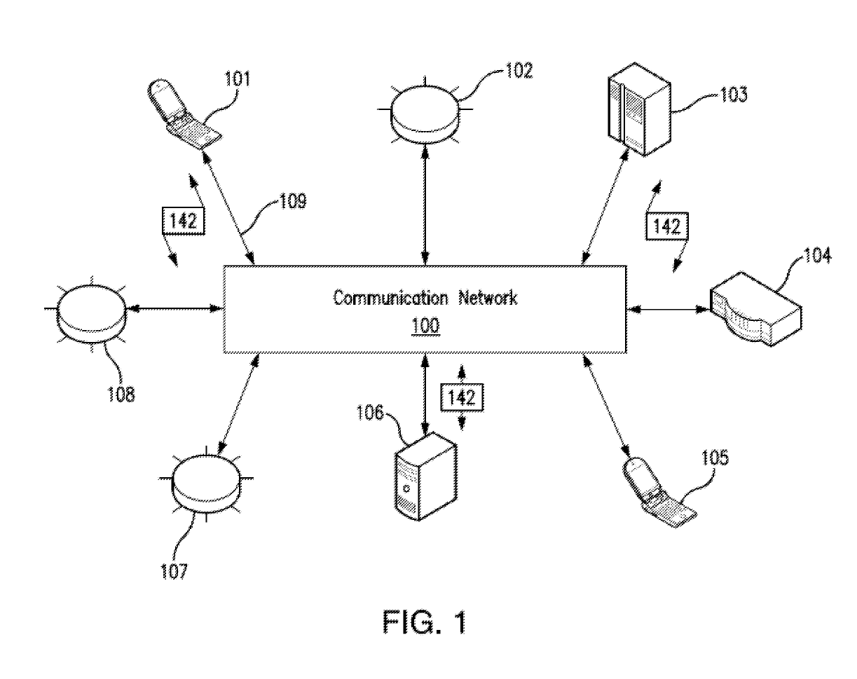

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a dwelling 300 or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, servers 106, routers 107, switches 108 and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

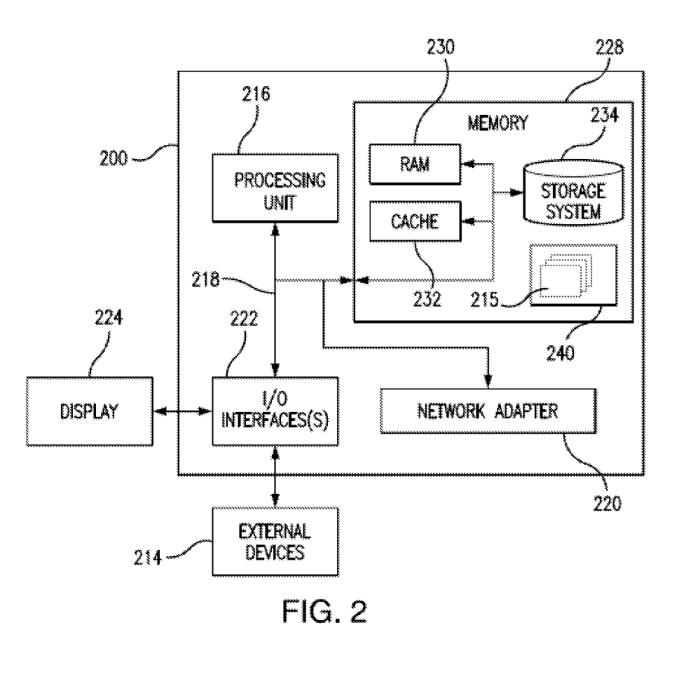

FIG. 2 is a schematic block diagram of an example network computing device 200 (e.g., one of network devices 101-108) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is only one example of a suitable system and is not intended to suggest any limitation as to the scope of use or functionality of embodiments of the invention described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as data analyzer module 306 described below, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

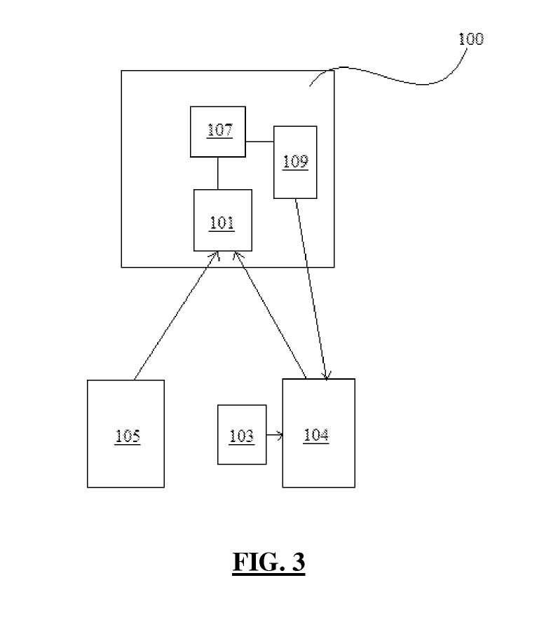

With the exemplary communication network 100 (FIG. 1) and computing device 200 (FIG. 2) being generally shown and discussed above, description of certain illustrated embodiments of the present invention will now be provided. With reference now to FIG. 3, a system 100 for preventing credit or debit card fraud can include at least one receiver 101 configured to receive and/or determine a location of the card 103, the location of usage of a card 103 at a time of usage of the card 103, and/or the location of an authentication device 105. The at least one receiver 101 can include separate receivers configured to receive and/or determine the locations of the card 103, the purchase location, and/or the authentication device 105 separately. The at least one receiver 101 can include any suitable computing device. The authentication device 101 can include any suitable computing device or apparatus that includes a suitable computing device (e.g., a mobile smart phone, a key-fob, a vehicle with a computing device).

The card 103 can be any suitable instrument, whether tangible (e.g., a physical card or information storing device) or intangible (e.g., account/card numbers and/or codes) that provide access to a line of credit and/or a bank account. Where a card 103 that is tangible is used, the location that is received or determined by the receiver 101 can include a physical location and/or IP address of the merchant 104 at which the card 103 is being used. Where a card 103 that is intangible is used (e.g., via an online purchase), the location of the device transmitting the card information can be received and/or determined by the receiver via an IP address of the transmitting device and/or any other suitable means. In such an embodiment, the location of the device transmitting the card information is the location of the card usage.

The system 100 can also include a comparison module 107 configured to receive and/or compare the location of usage of the card 103 to the location of the authentication device 105 and determine if the location of usage of the card 103 is within a threshold range of the location of the authentication device 105. Preferably, the authentication device 105 is a mobile computing device (e.g., smart phone, laptop, tablet device and the like) configured and operational to determine geographic positional data via any known means, such as, via a GPS receiver, triangulation and the like. The comparison module can be implemented via any suitable software and/or hardware on any suitable computing device. The threshold range can be modified by the card holder and/or the card issuer. It is to be appreciated, the threshold range may be prescribed by geo-fencing techniques.

An activation module 109 can be configured to allow the card 103 to function at the location of usage if the location of usage is within the threshold range of the location of the authentication device 105. The activation module 109 can be implemented via any suitable software and/or hardware on any suitable computing device.

In this respect, if the location of the card 103 and the authentication device 105 are located within a predetermined range, than the system 100 allows the purchase to be approved. If the location of the card 103 and the authentication device 105 are outside a predetermined range, than the system 100 does not allow the purchase to be approved without further authentication or approval from the card holder.

In some embodiments, the system 100 can include a receiver 101 that is configured to receive commands from a card holder to lock down the card 103 from being used and/or commands to allow the card to be used without specific authorization from the authentication device 105 operated by the user. The card holder can instruct the system 100 to allow purchases that meet predetermined criteria, e.g., within certain times and dates, at certain locations or areas, of a certain type of purchase, and/or by certain authorized users. Lock down of the card can be automatic if the predetermined criteria for purchase are not present.

Lock down of the card can also or alternatively be manually controlled for each purchase by the card holder through the authentication device 105. For example, a user can instruct the system to allow all purchases going forward until the user instructs otherwise. Alternatively, the user can select an automatic lock down at some predetermined and/or selectable time after the user instructs the receiver to allow purchases (e.g., about 5 minutes after authorization to lift the lock down is given).

In at least one aspect of this disclosure, the authentication device 101 (e.g., a mobile device) can include a location determination unit (e.g., a GPS unit) and a reporting module configured to selectively report a location from the location determination unit of the authentication device 101 to a system for preventing credit or debit card fraud. The reporting module can be implemented via any suitable software (e.g., an app, a retrofitted banking and/or credit card software application) and/or hardware on any suitable computing device.

In at least one aspect of this disclosure, a computer implemented method for determining a credit or debit card fraud can include receiving or determining a location of usage of a card, receiving or determining a location of an authentication device, comparing the location of usage of the card to the location of the mobile computing device, and determining if the mobile computing device and the card are in sufficient proximity to allow the card to be used.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer implemented method for determining a credit or debit card fraud, comprising:
receiving or determining a location of usage of a card;
receiving or determining a location of an authentication device;
comparing the location of usage of the card to the location of the mobile computing device; and
determining if the mobile computing device and the card are in sufficient proximity to allow the card to be used.

2. A system for preventing credit or debit card fraud, comprising:
at least one receiver configured to receive a location of usage of a card at a time of usage of the card and the location of an authentication device;
a comparison module configured to compare the location of usage of the card to the location of the authentication device and determine if the location of usage of the card is within a threshold range of the location of the authentication device; and
an activation module configured to allow the card to function at the location of usage if the location of usage is within the threshold range of the location of the authentication device.

3. A mobile device, comprising:
a location determination unit; and
a reporting module configured to selectively report a location from the location determination unit of the mobile device to a system for preventing credit or debit card fraud.
